(19) United States
(12) Patent Application Publication
(10) Pub. No.: US 2007/0289186 A1
(43) Pub. Date: Dec. 20, 2007

(54) A Method and Apparatus for Storing a Yarn Label and Yarn Identification Card

(75) Inventor: Jodi Meryl Wallace, Norwalk, CT (US)

Correspondence Address: JODI MERYL WALLACE, 9 LOCUST STREET, NORWALK, CT, 06855-2104, US

(73) Assignee: Jodi Meryl Wallace, Norwalk, CT (US)

(21) Appl. No.: 11/424,232

(22) Filed: Jun. 14, 2006

(51) Int. Cl. G09F 3/18

(52) U.S. Cl. 40/661

(57) ABSTRACT

A yarn label holder is provided for the storage of a manufacturer's yarn label and an identification card and includes a connecting elastic attachment that secures the yarn label holder to the yarn ball. The yarn label holder is comprised of two rectangles of transparent plastic material comprising a larger rectangle as the rear panel and a smaller rectangle as the front panel which are sealed together on all of its edges except for one side edge which is open and creates a pocket into which a yarn label and an identification card may be inserted for display through the transparent window. The rear panel of the yarn label holder contains one small hole through which a separate elastic cord is looped so as to allow for the secure attachment of the yarn label holder to the ball of yarn.

### REFERENCES CITED

U.S. PATENT DOCUMENTS

| | | |
|---|---|---|
| 1,208,827 | December 1916 | Pickering |
| 1,652,842 | December 1927 | Tanner |
| 2,618,086 | November 1952 | Konmorous |
| 2,725,913 | December 1955 | Honun |
| 4,000,570 | January 1977 | Carmen |
| 4,141,400 | February 1979 | Mangan |
| 4,518,080 | May 1985 | Olson |
| 4,616,435 | October 1986 | Perfect |
| 4,937,963 | July 1990 | Ba |
| 4,978,008 | December 1990 | Dalbo |
| 5,040,671 | December 1990 | Hager |
| 5,097,953 | March 1992 | Gingas |
| 5,121,563 | June 1992 | Connor |
| 5,522,163 | July 1994 | Neugebauer |
| Des 435,340 | December 2000 | Kojoori |
| 6,202,335 | March 2001 | Shelton |
| 6,308,831 | October 2001 | Tauber |
| 6,511,940 | June 2003 | Newman |
| 6,550,813 | April 2003 | Siegrist |
| 6,681,972 | January 2004 | Tapocik |
| 6,698,599 | March 2004 | Hannecke |
| 6,752,305 | June 2004 | Shattuk |
| 6,811,025 | November 2004 | Kaplan |

### BACKGROUND OF INVENTION

I. Field of Invention

The present invention relates to a method and apparatus for the storage and protection of a manufacturer's yarn label and an identification card for use by consumers who knit or crochet and relates to the consumer's need to secure the yarn label to a ball of yarn after it has been removed from the original packaging. A yarn label holder is comprised of two relatively thin, rectangles of transparent plastic material with a larger rectangle as the rear panel and a smaller rectangle as the front panel which are cohesively sealed together on all of its edges except for one side edge which is open and creates a pocket into which a yarn label and an identification card may be inserted for display through the transparent window. An elastic loop is integrated with the yarn label holder by means of being looped through a small punched hole in the back panel of the yarn label holder which allows the user to attach the yarn label holder to a ball of yarn and to utilize the elastic loop to keep the yarn ball from unraveling while stored. Currently no device exists which functions as a yarn label holder that stores and protects a yarn label and secures the yarn label to a wound ball of yarn once the label is removed from the original yarn packaging.

Over 53 million people in the North America are knitters and fiber artists who purchase yarn in skeins or balls to create numerous fiber articles for display or fashion. All yarn is labeled by the manufacturer with a paper label, also known as a ball band, which surrounds the yarn ball or skein and provides pertinent information including the name of the manufacturer, the name of the yarn, the composition of the yarn, washing instructions, gauge, color and dye lot. This band provides essential information that must be kept with the yarn for reference by the user. Because there is no such product of the nature of this invention, once the label is removed from the yarn skein, it is common for the user to discard or lose the label. This is a significant problem for knitters because without the ball band, there is no way to identify the yarn and its vital properties. Without the yarn label it is impossible to buy more of the same yarn from an unknown dye lot or to know how to care for the article made from the yarn. In addition, there is no method or apparatus that allows the knitter to annotate and record additional information about the yarn and attach that recorded data directly to the yarn to provide critical information such as where and when the yard was purchased, or how many yards remain at the completion of a project.

II. Discussion of Related Art

Devices for holding or displaying identification cards as well as card protection devices are well known. The use of identification holders is commonly used in the identification of employees for security purposes. These identification card holders or badge holders consist of familiar, expected and obvious structural configurations. U.S. Pat. No. 4,000,570 discloses an identification card holder in the form of a transparent plastic envelope open only at one end whereby an identification card can be inserted in and viewed through the holder and a safety pin having the pointed end portion extending through openings in the rear of said envelope for attachment to clothing of a user thereof and a method of forming said holders. The holder does not contain any means or apparatus that would serve to attach and wrap around a yarn ball. U.S. Pat. No. 6,848,207 discloses an identification badge assembly for identifying products and employees. The identification badge assembly includes a holder assembly and also includes a neck strap being attached to the support member and being adapted to be worn about a user's neck. The inventor does not teach or describe a means for securing the holder to an object for storage purposes. The following U.S. patents are believed to exemplify the state of the art with respect to the housing of identification cards: U.S. Pat. Nos. 5,592,767; 6,226,905; 6,086,707; 6,394,497; 6,681,972. The purpose of ID card holders is to attach the identification card to a person or object using a neck strap, pin, clasp or clip. Therefore, the need exists for a holder that retains a card within the holder while allowing it to be secured to a yarn ball by a means that would prevent the yarn ball from unraveling.

The use of card protection devices are wide spread in the application collecting baseball card, paper money and stamps. U.S. Pat. No. 5,010,673 discloses a plastic card holder having a clear base panel with a top surface that has a recessed portion for containing the display card and a plurality of flanges along the periphery of the base panel and extending upwardly to receive the insert transparent panel cover which has angled corners or notches around the periphery in positions corresponding to the flange on the base panel for releasable mating the base and insert panel. U.S. Pat. No. 6,149,003 discloses a system for protecting collectible cards and the like which is transparent card holder to house the collectible card and an authentication certificate. U.S. Pat. No. 5,040,671 discloses a transparent plastic case comprised of a first and second panel of matching elongated rectangle perimeter adapted to be cohesively sealed to enclose a collectible items. U.S. Pat. No. 4,829,691 discloses a display and protector device having transparent first and second panels connected together along a common hinge line. The following U.S. patents are believed to exemplify the present state of the art with respect to displaying and protecting sports cards and other related materials: U.S. Pat. Nos. 4,995,508 4,419,837 3,735,516, 5,249,383. Card protection devices are such that they are designed to contain and protect the collectible item, not to attach information externally to a product that requires identification. There is no attachment device associated with these apparatus. Therefore, the need exists for a holder that protects the yarn label and identification card and provides an apparatus for securing the holder to a soft object and preventing the yarn ball from unraveling.

Prior art also includes identification holders used in the application of attaching tags to merchandise for sale and luggage where the tag holder is external to the item to which it is attached and whose purpose is intended to permit easy identification. The following U.S. patents are believed to exemplify prior art with respect of housing identification tags: U.S. Pat. Nos. 4,187,628, 5,381,617. These holders are purposely intended to make it difficult for the identification holder to be removed. A further need exists for a holder that provides the flexible attachment of elastic to wrap around and secure the yarn ball.

None of the above inventions and patents, taken either singularly or in combination, ars seen to describe the instant invention as claimed. Thus, the method and apparatus for storing yarn labels, identifying yarn and attaching elastic loop that keeps the yarn from unraveling is most desirable.

### BRIEF SUMMARY OF THE INVENTION

The present invention relates to a method and apparatus for the storage and protection of a manufacturer's yarn label and an identification card for use by people who knit or crochet and relates to the consumer's need to secure the yarn label to a ball of yarn after it has been removed from the original packaging. A yarn label holder is comprised of two relatively thin, rectangles of transparent plastic material with a larger rectangle as the rear panel and a smaller rectangle as the front panel which are cohesively sealed together on all of its edges except for one side edge which is open and creates a pocket into which a yarn label and an identification card may be inserted for display through the transparent window. An elastic loop is integrated with the yarn label holder by means of being looped through a small punched hole in the back panel of the yarn label holder which allows the user to attach the yarn label holder to a ball of yarn and to utilize the elastic loop to keep the yarn ball from unraveling while stored.

It is an object of the present invention to provide a convenient and flexible method for identifying yarn by storing the original manufacturer's yarn label in a yarn label holder and conveniently attaching the yarn label holder to the original ball of yarn by way of an elastic loop. It is another object of the present invention to provide a clear, plastic sleeve in which to place the original manufacturer's label as well as an information identification card which allows the user to record additional pertinent information about the yarn such as date and location of purchase. It is yet another object of the present invention to attach an elastic loop to the plastic sleeve label holder to keep the yarn label holder attached to the yarn. It is yet another object of the present invention to attach an elastic loop to the plastic sleeve which is wrapped around the ball of yarn, thereby keeping the yarn from unraveling while it is stored. It is the object of the present invention to easily secure the yarn holder to the yarn but has the unique quality of being able to be easily and quickly removed. It is yet still another object of the present invention to provide a device as described above which has a limited number of parts, which is inexpensive to manufacture and is easy to use.

### BRIEF DESCRIPTION OF THE DRAWINGS

For a fuller understanding of the nature and objects of the invention, reference should be had to the following detailed description taken in connection with the accompanying drawings forming a part of this specification and in which similar numerals of reference indicate corresponding parts in all the figures of the drawing in which:

FIG. 1 shows a from view of the embodiment of a yarn label holder according to the present invention showing the front transparent panel adhered to the rear panel and illustrating the placement of one hole in the back panel.

FIG. 2 shows a perspective view of the yarn label holder according to the present invention showing the yarn label holder with one hole in the back panel through which an elastic loop is passed through the hole and through itself to secure the elastic loop to the yarn label holder;

FIG. 3 is a rear view of the yarn label holder according to the present invention showing how an identification card is inserted into the front panel of the yarn label holder and showing how the front and back display panels thereof are closed upon each other to protect the card and allow the display of the front and back of the identification card;

FIG. 4 is a perspective view of the front of the yarn label holder with the elastic loop securing the yarn label holder to a ball of yarn shown and functionally engaging in housing and displaying an identification card and accepting the insertion of a manufacturer's yarn label.

### DETAILED DESCRIPTION OF THE DRAWINGS

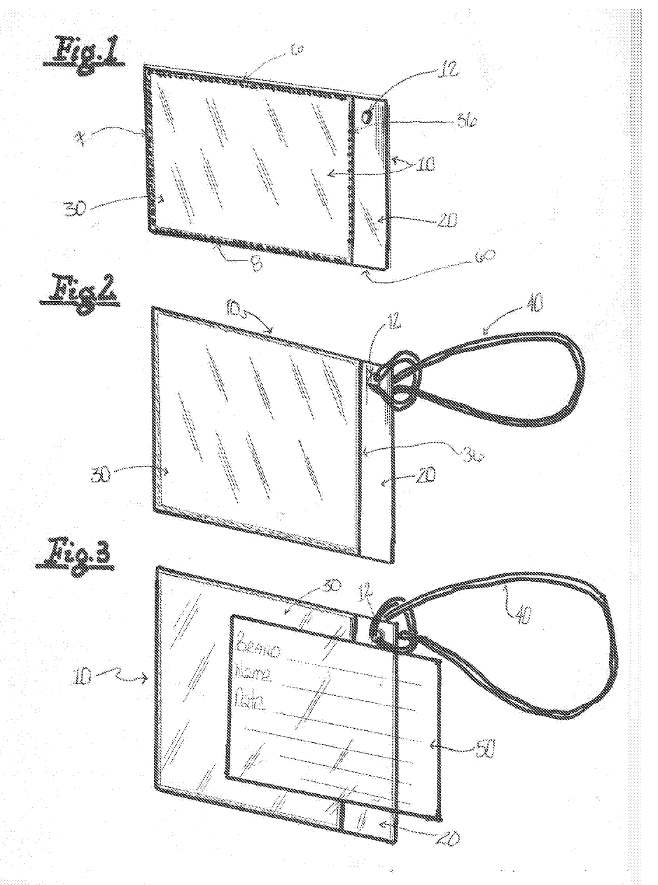

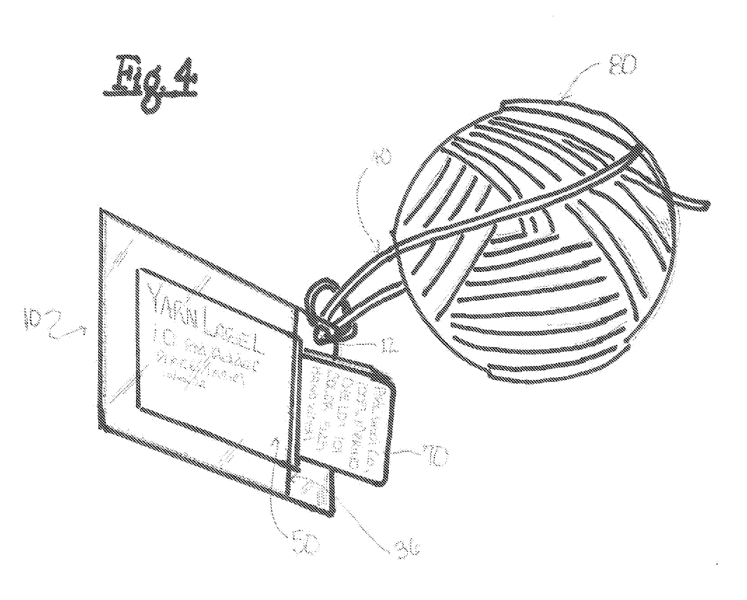

Referring now more in detail to the accompanying drawing wherein like and corresponding parts are indicated by the same reference characters, FIG. 1 generally indicates a yarn label holder 10 consisting of a transparent heat sealable plastic material having a front rectangular panel 30 and back rectangular panel 20. Front panel 30 is shorter than back panel 20 so that shortened edge 36 of front panel 30 is spaced inwardly from back edge portion 60 creating a side opening 36 into which an identification card 50 as shown in FIG. 3 and a manufacturer's yarn label 70 as shown in FIG. 4 can be inserted into the clear pocket and be viewed therethrough.

The top edge 6, end edge 7 and bottom edges 8 of said front panel 30 and back panel 20 are heat sealed together.

A small round hole 12 is punched into back panel 20 to allow an elastic loop 40 to pass through hole 12 as shown in FIG. 2. and to loop through the open end of the elastic loop thereby securing it to the yarn label holder 10.

FIG. 4. shows the yarn label holder 10 in its preferred embodiment wherein the yarn label identification card 50 and manufacturer's yarn label 70 are inserted into the open slot 36 and N elastic loop 40 is wrapped around a yarn ball 80 securing the yarn label holder and its contents to the ball of yarn.

The disclosure is provided for illustrative purposes and is not intended to limit the scope of the invention as claimed herein. Any variations in the exemplified articles which occur to the skilled artisan are intended to fall within the scope of the present invention.

What is claimed is:

1. A device for holding a yarn label and an identification card for identification purposes that is comprised of two rectangular sheets of flexible transparent plastic material, one larger than the other so that when sealed together on three sides creates an open pocket to hold the yarn label and identification card:

2. The yarn label holder according to claim 1, wherein an attachment of an elastic loop is passed through one small hole in the rear panel of the yarn label holder and looped through itself in order to secure the yarn label holder to the ball of yarn it is serving to identify:

3. An elastic loop attached to claim (1) which is used to secure the yarn and prevent it from unraveling.
